(19) United States
(12) Patent Application Publication
(10) Pub. No.: US 2008/0313629 A1
(43) Pub. Date: Dec. 18, 2008

(54) Method for installation of objects for a component-based management system for field devices of automation technology

(75) Inventors: Immanuel Vetter, Sinzheim (DE); Frank Birgel, Schopfheim (DE); Tobias Horn, Rheinfelden (DE); Alexander Schwalbe, Pforzheim (DE)

Correspondence Address: BACON & THOMAS, PLLC, 625 SLATERS LANE, FOURTH FLOOR, ALEXANDRIA, VA, 22314-1176, US

(73) Assignee: CodeWrights GmbH, Karlsruhe (DE)

(21) Appl. No.: 12/003,413

(22) Filed: Dec. 26, 2007

(30) Foreign Application Priority Data
Dec. 29, 2006 (DE) 10 2006 062602.8
Dec. 4, 2007 (DE) 10 2007 058609.6

(51) Int. Cl. G06F 9/445

(52) U.S. Cl. 717/174

(57) ABSTRACT

A method for installation of objects for a component-based management system for field devices of automation technology, wherein the management system includes a frame application and a plurality of device managers which can run in the frame application, it is checked in the installation of new objects that such are not inconsistent with earlier installations.

Field devices are commonly employed in automation technology (process automation/manufacturing automation) and serve for registering and/or influencing process variables. Examples of such field devices are fill level measuring devices, mass flow measuring devices, pressure- and temperature-measuring devices, pH- and redox-potential-measuring devices, conductivity measuring devices, etc. for process automation technology, which, as sensors, register the corresponding process variables, fill level, flow, e.g. flow rate, pressure, temperature, pH-value and conductivity value, respectively.

Serving for influencing process variables are actuators, e.g. valves, which control flow of a liquid in a section of pipeline, or pumps, which change fill level in a container.

A large number of such field devices are manufactured and sold by the firm, Endress+Hauser®.

Frequently, field devices are connected with superordinated units via communication systems (Profibus®, Foundation®-fieldbus, HART®, etc.). Such superordinated units serve for process control, process visualization, device-management (configuration and servicing) and for plant management (asset management), using corresponding application programs.

The integration of field devices into such applications occurs via device descriptions. Device descriptions are provided by device manufacturers, in order that superordinated units can recognize and interpret the meaning of data supplied by the field devices.

Various device descriptions are known for the different fieldbus systems (HART-device-descriptions, Fieldbus Foundation device descriptions, Profibus device descriptions).

On the basis of cooperation of Fieldbus Foundation (FF), HART Communication Foundation (HCF) and Profibus Nutzerorganisation (PNO), an electronic device description (Electronic Device Description EDD) was created, which is defined in the standard, IEC 61804-2.

With a large number of EDD-based fieldbus systems installed worldwide, EDD is a very widely used description language for device descriptions in automation technology.

For servicing field devices, corresponding servicing programs (operating tools) are necessary, which, in superordinated units, run either on their own (Endress+Hauser FieldCare, Pactware, AMS Fisher-Rosemount, PDM Siemens) or else are integrated into control system applications (Siemens PCS7, ABB Symphony, Emerson Delta V).

For a comprehensive servicing of field devices, newly, special device descriptions, so-called DTMs (Device Type Manager), are available, which correspond to the FDT (Field Device Tool) specifications. The FDT-specifications, serving as an industry standard, were developed by the PNO (Profibus Nutzer Organisation (Profibus User Organization)) in cooperation with ZVEI (Zentralverband Elektrotechnik- und Elektroindustrie (The German Electrical and Electronics Industry, a registered association)). The current FDT-Specification 1.2.1, including the Addendum for “Foundation Fieldbus” Communication, is available from ZVEI, PNO or the FDT-Group.

Many field device manufacturers already deliver corresponding DTMs for their field devices. The DTMs encapsulate all variables and functions of the pertinent field device and offer, most often, a graphical user interface for servicing the devices.

As run-time environment, the DTMs require a frame application (FDT-frame). The frame application and the corresponding DTMs permit, thus, a very comfortable access to field devices (e.g. to device parameters, measured values, diagnostic information, status information, etc.), as well as serving for invoking special functions, which individual DTMs make available.

Frame applications and DTMs form together a component-based management system for field devices.

For installing DTMs, an executable installation program (setup.exe) is necessary, which copies all of the needed files onto the computer system on which the frame application is running and makes all necessary entries in the Windows registry. Production of the installation program is, along with the development of the DTMs, a very important task. Malfunctioning installation programs can lead to undesired system crashes, which is very disturbing for a user.

The installation program must perform the same tasks that an installation program for a Windows application does, i.e. control elements (Active X-controls) and COM-objects must be installed, system libraries (DLLs) updated, help-files copied, etc. Here, it's quite important to check that, after the installation procedure, all previously available DTMs and all newly added DTMs function faultlessly. Also, other programs must not suffer any loss in function.

It is state of the art to install individual DTMs. In the case of applications with many field devices, however, this can lead to a no longer manageable number of entries in the Windows control panel.

The applicant, the firm, Codewrights, offers a DTM library, which includes a large number of field device types. The DTM library is, in principle, one DTM, which is composed of a large number of components (main object, sub-objects).

Use of a DTM library means a smaller test effort and less storage space requirement for the installation.

It is state of the art that, when changes to components were made, the entire DTM library had to be installed anew. This is very time consuming for the user. Since the DTM library represents a very large amount of data (over 500 MB), transmission via Internet at low transmission speeds (e.g. 56 K modem) is extremely slow. For the manufacturer of the DTM library, this means that updating the DTM library can only occur relatively infrequently (circa 4× yearly). For each new version of a DTM library, corresponding data carriers (CD ROMs) must be provided.

An object of the invention is, therefore, to provide a method for installing objects for a component-based management system for field devices of automation technology, which method does not exhibit these disadvantages.

This object is achieved by the features given in claim 1.

Advantageous further developments of the invention are given in the dependent claims.

An essential idea of the invention is, in the case of an installation, no longer to install the entire DTM library, but, instead, only certain parts (components or objects). Since the device managers (DTMs) are modularly structured and are composed of a main object and a plurality of sub objects, it is necessary to check in the case of each installation, whether the new installation has changed dependencies between objects of earlier installations.

The new installation therefore knows the history of all earlier installations (setups).

When a main object of an earlier installation is no longer needed, because all device managers are instantiated via other main objects, the earlier installed main object and all sub-objects dependent on this main object can be uninstalled.

With the method of the invention it is no longer necessary that a full installation of the DTM library be done. Instead, partial installations (partial setups) can be performed. By the method of the invention, it is assured that, following an installation, no conflicts exist between individual DTMs.

In an advantageous further development of the method of the invention, the installation package is expanded by expanding the installation program with the two following added sub-functions:
A test function, which checks for correct installation of the installation package and generates a report in the case of error; and
A cleanup function, with which the no longer needed installation package can be uninstalled. Involved, in such case, is, especially, a so-called low-level removal.

The invention will now be explained in greater detail on the basis of an example of an embodiment presented in the drawing, the figure of which shows as follows:

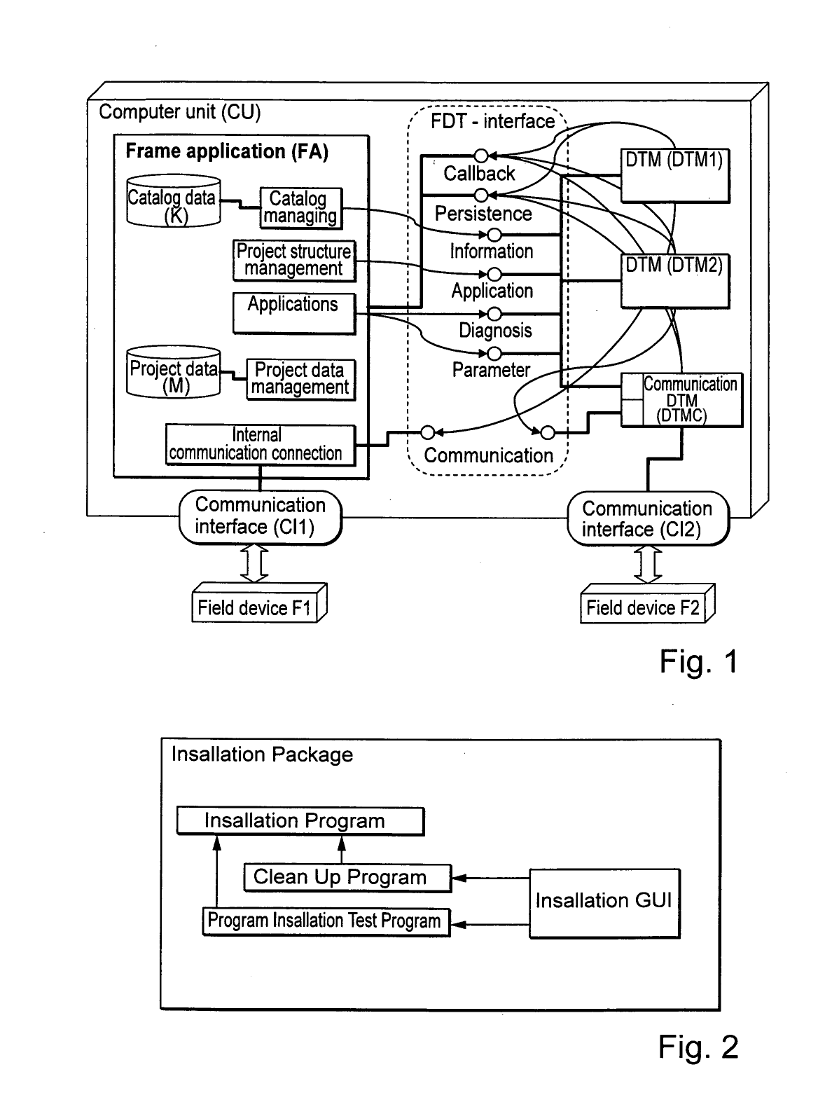

FIG. 1 basic structure of a component-based management system for field devices of automation technology; and

FIG. 2 a schematic illustration of the structure of an installation program of the invention, with added functions.

FIG. 1 shows, schematically, the basic structure of a component-based management system for field devices of automation technology. The management system is based on the FDT concept. A frame application FA, which runs on a computer unit CU, communicates via defined FDT-interfaces FDT with device manager instances DTM1, DTM2, which enable a comprehensive servicing of the field device types associated with the respective device managers. The frame application FA also communicates with the communication manager instance DTMC, which enables a comprehensive servicing of the interface. The frame application FA can be, for example, the product FieldCare® of the firm, Endress+Hauser. Frame application FA serves for, among other things, managing and instantiating various objects; in such case, the frame application is responsible for building the project structure, establishing connections between device- and communication-manager-instances, starting and managing applications, storing and loading project data, as well as production and destruction of projects.

For managing project structure, each device manager and communication manager offers information via its Information interface. On the basis of this information, the frame application FA can accumulate catalog data K needed for managing project structure. With the project structure, the frame application controls and manages also the communication paths. FIG. 1 shows two communication networks (e.g. fieldbuses), which are accessed via communication interfaces CI1, CI2. The device manager instances do not communicate with the field devices directly, but, instead, utilize the communication interface of FDT, which can be offered both by the frame application FA and also by a communication-manager instance. In FIG. 1, the device manager instance DTM1 communicates via a communication interface C11 in the frame application FA with the field device F1 associated therewith, while the device manager instance DTM2 communicates with the field device F2 with the help of the communication-manager instance DTMC via a communication interface CI2. Frame application FA manages applications, which are part of the frame application, as well as also managing device manager- and communication manager-specific applications. Internal applications of the frame application FA, such as diagnostic methods and data registering, use the FDT interfaces for exchanging data with the device- and communication-manager-instances. Device manager- and communication manager-specific applications are managed by the frame application by means of an Application interface. The frame application queries, for this purpose, via an Information interface, type and number of the available applications.

The persistence of the project data is implemented by the frame application FA with the help of a Persistence interface, which are served by the device- and communication-manager instances.

Frame application FA forms, together with the device manager instances DTM1, DTM 2 and the communication manager instance DTMC, etc., an object-based configuration system CS for field devices of automation technology.

As already mentioned, field device manufacturers make device managers available for their individual field devices. Before a field device can be accessed, the corresponding device manager, with all belonging objects, must be instantiated. The device managers comprise main objects and sub-objects

The method of the invention will now be explained in greater detail.

As already mentioned, for each type of field device, a description of the dependencies is present, regarding which objects, i.e. main object and sub-objects, are associated with a device manager. Associated with the installation program is a database, in which the individual objects are stored and in which also the dependencies of all objects (main objects, sub-objects) are stored. According to the invention, it is ascertained which older installations were already performed in the computer unit. Additionally, it is reviewed, which databases of earlier installations in the computer unit are present. Moreover, it is checked, which objects are already available in the system. Important, above all, is that no inconsistencies exist between dependencies of earlier installations and the dependencies defined in the current installation. This must likewise be reviewed. When new dependencies are present, these can only be accepted, when no inconsistencies exist with respect to earlier defined dependencies. If earlier installations are no longer needed, the objects associated with an earlier installation can be erased.

With the method of the invention, it is possible, for example, that only objects with help-texts are installed.

Additionally, it is possible with the method of the invention that only objects for individual field devices are installed. In this way, device managers for individual field devices can be updated more rapidly and the installation is significantly less complicated than in the case of the use of the DTM library.

With the method of the invention, it is also possible that the user selects, for example via Internet, specific device managers out of a library containing a number of device managers and that only an installation program for these selected device managers is transmitted to the computer unit on which the frame application is running.

In this way, the scope of an installation program (setup) is significantly decreased. This enables, for example, also a transmission of the entire installation program also at a slow transmission speed via the Internet.

FIG. 2 shows a schematic illustration of the installation package of the invention, composed of installation program and GUI, with the installation program including the two advantageous, added functions.

Usually, an installation package containing a selection of device objects, for e.g. field device parametering, is composed of different kinds of modules:
Modules with internally developed components
Modules with externally developed components

Externally developed and purchased components are supplied as closed modules without source code. There is a danger that such modules have hidden errors, which can negatively affect the installation process. Problematic is, especially, that these errors remain undiscovered in given tests, because they arise only under certain conditions and constellations. The errors can be of various types:
The software is correctly installed, but does not function.
The software installs correctly, even functions, but does not allow itself to be uninstalled.
An upgrade can not be installed, because the old version can not be uninstalled.

In an advantageous further development of the method of the invention, the installation package is expanded with the two following added sub-functions:
A test function, which checks for correct installation of the installation package and generates a report in the case of error; and
A cleanup function, with which the no longer needed installation package can be uninstalled. Involved in such case is, especially, a so-called low-level removal.

The two functions are preferably embodied as program modules and integrated into the installation description file/installation program. The installation test checks all Windows registry entries and files on the computer unit CU of the user and reviews, whether installed entries and files are damaged and whether they are present in the correct versions. If an error is found, a report is generated, which can be used for error diagnosis. Additionally, the user can forward the error report directly to a support-department.

The cleanup function removes the installation package without Windows® standard mechanisms. This program makes it possible to remove the installation package, even when such is not possible with Windows®.

1-7. (canceled)

8. A method for installation of objects for a component-based management system for field devices of automation technology, wherein the management system comprises a frame application and a plurality of device managers executable in the frame application, comprising the steps of:
providing device managers which are modularly structured and include main objects and sub-objects;
providing for each type of field device a description of dependencies which tells which objects are associated with a device manager; and
providing a data base associated with the installation, in which individual objects are stored and in which dependencies of all objects are stored, wherein:
in the installation, it is checked:
which earlier installations were already performed;
which databases are present;
which objects are present and which objects must be newly installed;
whether there are inconsistencies between dependencies of earlier installations and dependencies defined in the current installation;
whether new dependencies are present, and, if so, such new dependencies are accepted only when no inconsistencies are present; and
that earlier installations and objects associated with these installations are erased, when such are no longer needed.

9. The method as claimed in claim 8, wherein:
only objects with help-texts are installed.

10. The method as claimed in claim 8, wherein:
only objects for individual field devices are installed.

11. The method for selection of device managers for a method as claimed in claim 8, wherein:
a user selects specific device managers from a library containing a plurality of device managers; and
transmitting an installation file for these selected device managers to a computer unit on which the frame application is running.

12. The method as claimed in claim 11, wherein:
the specific device managers comprise device managers for a specific measurement principle (e.g. fill level, flow, temperature).

13. The method as claimed in claim 8, wherein:
in at least one of the following functions is implemented as a program module in an installation program:
A function for installation testing, with report generation,
A function for removing installed objects or an installation file.

14. The method as claimed in claim 13, wherein:
an installation test is performed and a protocol is created during installation, which protocol is used for error analysis.
